(19) United States
(12) Patent Application Publication
(10) Pub. No.: US 2003/0206312 A1
(43) Pub. Date: Nov. 6, 2003

(54) Method and apparatus for integrating remote print-on-demand services into a local printer driver

(75) Inventors: David A. McAfee, Spring, TX (US); Derrill Sturgeon, Spring, TX (US); David C. Vinson, Cypress, TX (US); John R. Christy, Houston, TX (US)

Correspondence Address: CONLEY ROSE, P.C., P. O. BOX 3267, HOUSTON, TX, 77253-3267, US

(73) Assignee: Compaq Information Technologies Group, L.P., Houston, TX

(21) Appl. No.: 10/136,549

(22) Filed: May 1, 2002

(51) Int. Cl. G06F 15/00; G06K 1/00; B41B 1/00

(52) U.S. Cl. 358/1.15; 358/1.13

(57) ABSTRACT

A printer driver integrates local and remote printing. A computer is coupled to a local printer. The computer also has access via a network connection to one or more remote printers or printing services. The computer may access the remote printers via the Internet or other wide area network. Using the printer driver, a user can send print jobs either to the local printer or a remote printer. Preferably, the coordination of the local and remote printing capabilities of the computer and printer driver is transparent to the user. That is, the user can initiate a print job from any authoring application (e.g., word processor) and have that print job sent either to the local or remote printer via a common user interface provided by the printer driver.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to on-line print-on-demand services. More particularly, the invention relates to a printer driver that integrates remote printing and local printing. Still more particularly, the invention relates to a printer driver and a rules based system that permits local or remote printing and determines a suitable on-line print service for fulfilling the needs of particular print job.

2. Background Information

Computers and computer printers long ago replaced typewriters for the bulk of all document creation and printing in homes and businesses. Being able to print a document on a computer attached to a computer is commonplace and even the most novice of computer users readily knows how to print a document. The action of printing a document generally entails selecting the “print” option under the “file” menu in a Windows® environment. Similar actions are provided under different operating system environments. Thus, printing on a local printer simply requires one or two “clicks” of a mouse button.

Most locally attached printers generally range from the less expensive inkjet printers to more expensive black and white laser printers. While such printers have become invaluable for quickly printing small quantities of text documents, photographs, and other types of documents, there are many other types of printing that are beyond the capabilities of small inkjet or laser printers. In the small to medium business environment, such print jobs may include mass mailings, advertisements, fliers, business cards and catalogs. Consumer users might be interested in printing banners, posters or high-quality photographs. The aforementioned are examples of jobs that use paper as the print medium. In addition to printing on paper, business and consumer users might be interested in printing images or logos on coffee cups, mouse pads, shirts, ceramic tiles, cakes, etc.

Printing services are available for accomplishing all of these tasks, but most of them are obscure, relatively inaccessible and cumbersome to use for typical computer users. Many of these printing services are available on-line. To use such an on-line service, a user first would have to be aware of such a service. In today's Internet world with millions of websites, it is highly unlikely that most users are aware of all of the printer service providers. Second, the user would have to enter into a relationship with each on-line print service and manage and interact with each print service separately.

At least one remote printing service has been described as providing a user with a printer driver associated each on-line print service the user wishes to use. Thus, if the user wants to be able to use five different print service, the user would have to download five different virtual printer drivers, one associated with each print service. Then, when the user wishes to submit a print job for remote printing, the user would have to determine which of the on-line print services would be acceptable or best for handling the specific print job. At that point, the user would select the printer driver associated with the print service the user determined to be most suitable for the job. The selected printer driver then activates the user's Internet connection which submits the print job to the on-line service associated with the selected printer driver.

As explained above, this type of service places a considerable burden on the user. The user is forced to download a separate printer driver for each on-line print service and, for each print job, determine which one of multiple print services would be most suitable. A system that avoids these issues and problems would be highly desirable.

### BRIEF SUMMARY OF THE PREFERRED EMBODIMENTS OF THE INVENTION

The problems noted above are solved in large part by a printer driver, which runs on a computer, and that integrates local and remote printing. The computer is coupled to a local printer, either directly or indirectly via a local area network. The computer also has access via a network connection to one or more remote printers or printing services (collectively referred to as “remote printers”). The computer may access the remote printers via the Internet or other wide area network. Using the printer driver, a user can send print jobs either to the local printer or a remote printer. Preferably, the coordination of the local and remote printing capabilities of the computer and printer driver is transparent to the user. That is, the user can initiate a print job from any authoring application (e.g., word processor) and have that print job sent either to the local or remote printer via a common user interface provided by the printer driver.

In one embodiment, the printer driver contains, or has access to, a set of print rules. Each print rule defines a condition, or set of conditions, pertaining to a user-requested print job and a printer associated with each condition. The printer associated with each condition is a local printer or a remote printer. Once the user has selected one or more characteristics of the print job (e.g., media type, paper size, quantity, etc.), the printer driver compares the user-defined print job to the set of print rules to determine whether to send the print job to a local printer or remote printer. The printer driver also makes available attributes specific to the print service offered, for example, duplexing, bookletting, binding and media types. The driver tranlates the content created on the user's computer into a format the print service requires. The printer driver sends the print job to the printer associated with the rule that matches the user's print job.

The print rules may be downloaded into the user's computer during system initialization or at other times or, as described below, be generated by the user's computer based on printer information downloaded to the computer. The print rules preferably take into account the capabilities of the user's local printer relative to the capabilities of the remote printers. An on-line remote printing facilitator is also accessible to both the computer and the remote printers. The remote printers preferably register themselves with the remote printing facilitator. This registration process includes providing information concerning the capabilities of the remote printer. Further, each user preferably registers with the remote printing facilitator to provide name and address and other suitable information. The remote printing facilitator downloads this information to the computer along with information concerning the capabilities of some or all of the printers which could be used as a local printer. In one embodiment, the computer then generates the print rules using the downloaded information and given the particular local printer accessible to the computer. Preferably, any print job which can reasonably be performed by the local printer is sent to the local printer, and other print jobs are sent to a suitable remote printer. The printed results of remotely printed print jobs can be mailed to the user using the user's address provided by the remote printing facilitator. Alternatively, the print job itself can include name and address and account information when sent to the remote printer.

By integrating local and remote printing into a single printer driver, a user can easily and quickly initiate print jobs to an appropriate printer, even if that printer is remotely located from the user's computer. These and other advantages will become apparent upon reviewing the following description.

### BRIEF DESCRIPTION OF THE DRAWINGS

For a detailed description of the preferred embodiments of the invention, reference will now be made to the accompanying drawings in which:

FIG. 1 shows a system diagram in accordance with the preferred embodiment of the invention in which print jobs can be sent by a computer to a locally-coupled printer or a remote printer;

FIG. 2 shows a block diagram of the computer of FIG. 1;

FIG. 3 shows an exemplary user interface associated with a printer driver that integrates local and remote printing;

FIG. 4 shows a system diagram including a remote printing facilitator that can be used to register remote printing services and users;

FIG. 5 shows another user interface associated with the printer driver; and

FIG. 6 shows an exemplary embodiment of a set of print rules used by the printer driver to determine whether a print job should be sent to a locally-coupled printer or a remote printer.

### NOTATION AND NOMENCLATURE

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections.

The terms “local printer” and “remotely-coupled printer” refer to the location of the printer vis-à-vis the computer which initiates the print job. A local printer refers to a printer directly connected to the computer or a printer coupled to the computer via a local area network, such as in an office environment. A local printer generally is owned and operated by the same entity which owns and operates the computer. A remotely-coupled printer includes a printer operatively coupled to the computer via a wide area network, such as the Internet. This type of printer may include printing services unrelated to the entity which owns and operates the computer and which have their own printer(s). Remote printers may comprise remote printing services. Such printing services may be on-line application service providers (“ASPs”) and, as such, may comprise a plurality of printing devices.

To the extent that any term is not specially defined in this specification, the intent is that the term is to be given its plain and ordinary meaning.

### DETAILED DESCRIPTION OF THE PREFERRED EMBODIMENTS

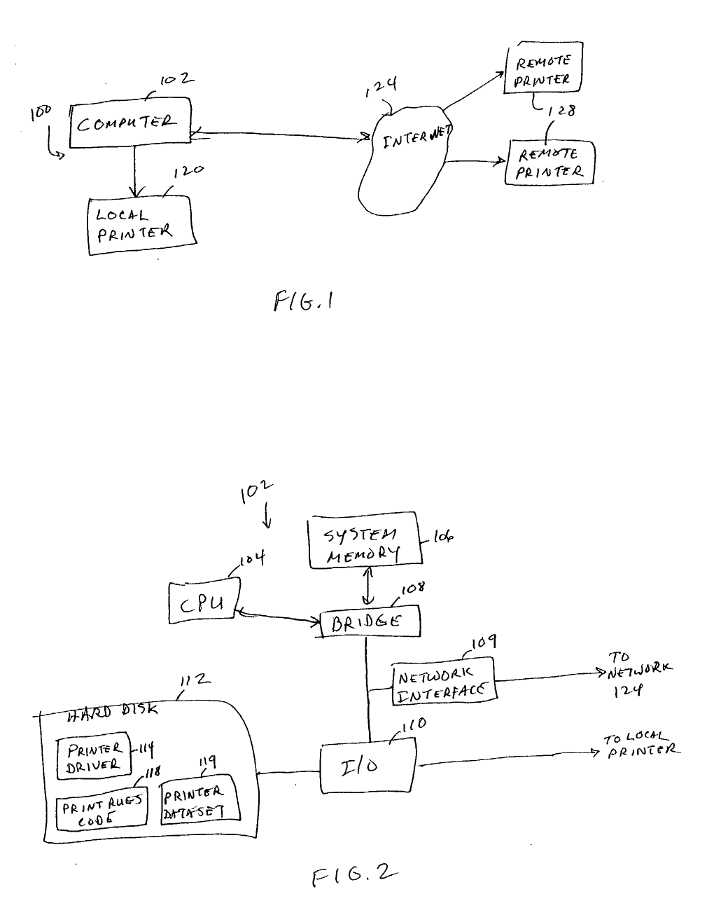

Referring now to FIG. 1, in accordance with the preferred embodiment of the invention, a computer system 100 includes a personal computer 102 and a local printer 120 coupled thereto. The personal computer 102 can be, in general, any type of electronic device through which a user might wish to initiate a print job. The computer 102 can be any type of consumer or business computer, a desktop machine, a laptop computer, or a handheld computing device. The local printer 120 may be any type of printer and can be connected directly to computer 102 or coupled to computer 102 via a network link. Further, more than one local printer can be made available to computer 102. As is well-known, computer 102 includes a printer driver which is executable software that interfaces the computer 102 to the particular local printer 120. Using the printer driver, a document on the computer 102 can be printed on the local printer 120.

Via a network 124, the computer 102 also couples to one or more remote printers or printing services 128. The network 124 may comprise the Internet or, more broadly, any wide area network. The remote printers 128 may be individual printing devices coupled directly to the network 124 or coupled to the network via interfacing logic, such as a server (not shown).

In accordance with a preferred embodiment of the invention, using computer 102, a user can print on the locally-coupled printer 120 or on one or more of the remote printers 128. Preferably, the printer driver running on the computer 102 includes the ability to either cause a print job to be submitted to the local printer 124 or to one of the remote printers 128. Thus, remote print-on-demand services are integrated into the printer driver. The resulting printer driver makes remote printing by a user very simple. In short, printing at a remote printer becomes as easy as printing on a locally-coupled printer 120. Moreover, a user can initiate printing, both locally and remotely, via any authoring application (e.g., word processing, spread sheet, etc.).

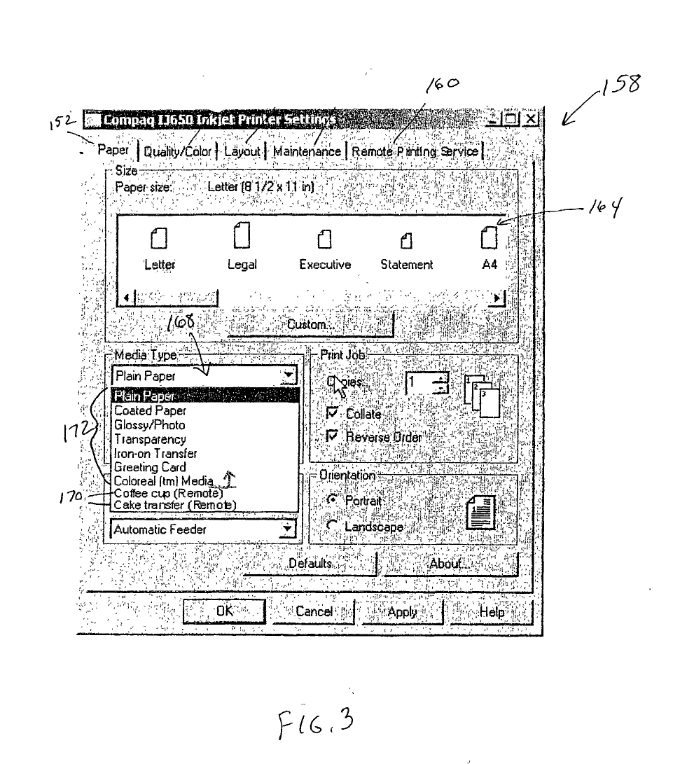

Referring now to FIG. 2, a block diagram of computer 102 is shown in accordance with a preferred embodiment. As shown, computer 102 includes a central processing unit (“CPU”) 104, system memory 106, a bridge device 108, and I/O interface device 110, and a mass storage device 112. Other components may also be included, but have been omitted from the drawing of FIG. 2 for sake of clarity. The bridge device 108 preferably couples together the CPU 104, system memory 106, which comprises any type of volatile memory, I/O interface device 110, and a network interface 109. The mass storage device 112 may comprise any suitable type of non-volatile storage device such as a hard disk drive. The hard disk drive 112 couples to the I/O interface device 110. The local printer 120 also couples to the I/O interface device 110. The network interface may be a network interface card (“NIC”) or device or modem or any other type of network interface, and permits the computer 102 to communicate with the network 124. The configuration of components in FIG. 2 is exemplary of one embodiment of computer 102 and numerous other architectural configurations are also possible.

Computer 102 includes one or more applications and other types of executable routines that are executed by CPU 104. In general, such executable programs reside on hard disk drive 112 and are copied to system memory 106 and executed therefrom. One such program is a printer driver 114. The printer driver 114 includes a number of features. One such feature is the ability to permit print jobs to be submitted to the locally-coupled printer 120 in accordance with known printer driver technology.

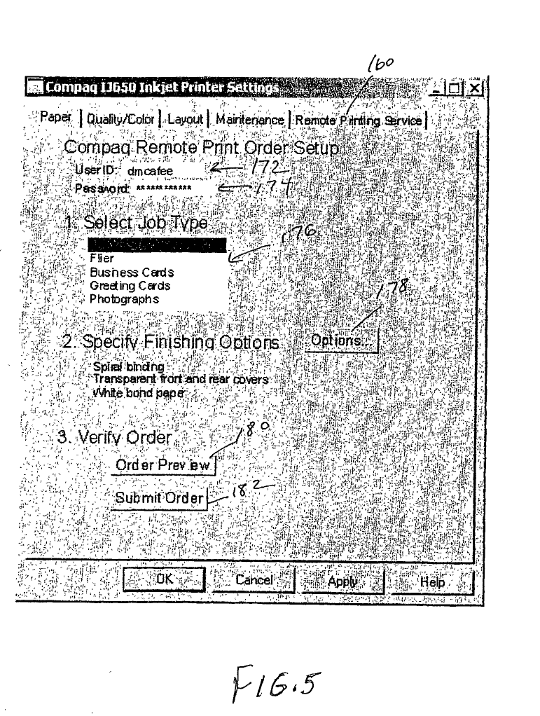

Another feature incorporated into printer driver 114 is the ability to initiate a print job to a remote printer 128 via network interface 109. As such, remote and local printing are integrated together via a common printer driver. FIGS. 3 and 5 show two ways in which printer driver 114 can be used to initiate local and remote printing. Referring first to FIG. 3, a graphical user interface 158 is shown comprising a number of selectable features that are used to control printing. A plurality of “tabs” are shown at the top of the user interface 158. The tabs include “paper” 152, “quality color,” layout, “maintenance” and “remote printing service” 160. The rest of the user interface in Figure comprises the selectable features under the “paper” tab 152.

Referring still FIG. 3, a paper size menu 164 is shown providing various paper sizes such as letter, legal, executive, statement and A4. A plurality of media types 168 are also provided. Other selectable features are also included such as the number of copies to be printed, whether the print job should be collated, whether the job should be printed in reverse order, and whether the job should be printed in portrait mode or landscape mode. Other, or different, selections can be made available in graphical user interface 158.

The media types generally include two broad categories. A first category 172 includes different types and qualities of print media that can be used in conjunction with locally-coupled printer 120. Examples of local printer media types include plain paper, coated paper, glossy/photo, transparency, iron-on transfer, greeting card, and coloreal (tm) media. Other, or different, media selections can be included as part of printer driver 114's graphical user interface 158.

The second category 170 of media types include selections that, when selected, cause computer 102 to send the associated print job to a remote printer 128. Examples of such remote media types include, but are not limited to, coffee cup and cake transfer. In accordance with a preferred embodiment of the invention, when the user selects a media type from the first media category 172, the print job is directed to a locally-coupled printer 120. When the user selects a media type from the second category 170, however, the print job is directed to a remotely-coupled printer 128.

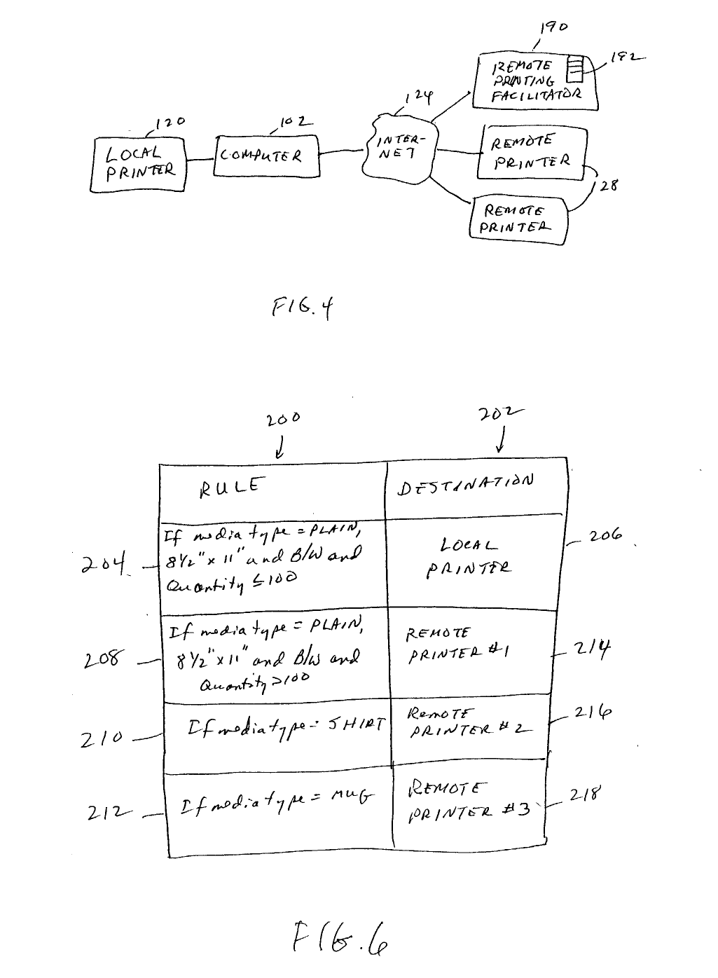

In accordance with the preferred embodiment of the invention, several features may be included to facilitate remote printing. One such feature includes the user of computer 102 registering with a remote printing facilitator as shown in FIG. 4. The facilitator (190) preferably is an entity to which the user connects to provide information such as name, address, telephone number, an account number, personal ID number (“PIN”), and any other, or different, information useful to the printing services. Once the user is registered, the user's account number, PIN, etc. is entered in to, or otherwise made accessible to, the printer driver 114. The driver 114 then passes this user-specific information on to the remote printer 128 along with the print job itself. In this way, printing and billing will be seamless and transparent to the user. Further, because the print job includes information that uniquely identifies the user, the status of the user's print job can be made available on line to the user either by the remote printer 128 or the remote printer facilitator 190.

Referring still to FIG. 4, the remote printers 128 also access the remote printing facilitator 190 to register themselves. The information provided by the remote printers 128 to the facilitator 190 may at least include information regarding the capabilities of the remote printer. Examples of such information may include the remote printer's printing rate (number of pages per minute), media type, whether the remote printer includes color capabilities, pricing, etc. The remote printer 128 also provides its location and demographic information to the facilitator such as an Internet Protocol (“IP”) address, uniform resource locator (“URL”), mailing address, telephone number, contact name, etc.

FIG. 5 shows an alternative method for initiating remote printing through a printer driver. Specifically, FIG. 5 shows the configurable features under the remote printing service tab 160. As shown, user ID and password values are entered in fields 172 and 174, respectively. These values preferably are assigned to the user or selected by the user during the registration process explained previously. These values may be the same as, or different from, tie account number and PIN values noted above. In field 176, a job type can be selected. The exemplary job types shown in FIG. 5 include flier, business cards, greeting cards, and photographs. Provisions for different and/or additional job types can be provided. Options button 178 can be included if desired to permit a user to specify one of a variety of finishing options such as whether the job should be bound, the type of binding, type of paper to be used, etc.

The order preview button 180 can be selected to preview the order on the computer 102 before the computer submits the job to the remote printer 128. This type of preview might be similar to the “print preview” feature common to many authoring applications. Finally, the user can activate the submit order button 182 to cause computer 102 to transfer the print job to the remote printer 128.

In accordance with one embodiment of the invention, the printer driver 114 is configured to send remote print jobs to a single remote printer destination. That is, when a selection is made that results in a print job being sent to a remote printer 128, the print job is sent to a single predetermined printer 128. The printer driver 114 can be preset for a particular remote printer 128 or can be programmed as desired by the user.

Rather than configuring the printer driver 114 for a single remote printer 128, the printer driver can cause a print job to be sent to any one of a plurality of remote printer destinations. In one embodiment of this feature, each remote printer-related selection in FIGS. 3 and 5 (e.g., coffee cup or cake transfer selections 170 or any of the job types 176) can be associated with a remote printer destination that may be the same or different from other such remote printer-related selections. For example, selecting the coffee cup media type in FIG. 3 may cause the print job to be sent to one remote printer 128, while selecting the cake transfer media type may result in the print job being sent to a different remote printer 128.

Referring again to FIG. 2, in accordance with another embodiment, the computer 102 may include a remote print rules code 118 which is executed by CPU 104. This piece of code may run as a background application. Remote print rules code 118 includes, or otherwise has access to, a set of rules that are applied to the printing criteria selected by a user. As the user navigates through the interfaces in FIGS. 3 and/or 5 and selects the various print options present therein, a collection of printing criteria is assembled by the printer driver 114. The remote print rules code 118 then compares the print options selected by the user to the print rules and performs an action regarding the processing of the print job as a result.

In one embodiment, the remote print rules code 118 determines whether the print job created by the user is best suited for local printing or remote printing. Further, if it is determined that remote printing is better suited for the print job, the remote print rules code 118 may also determine which remote printer 128 to fulfill the print job. These determinations preferably are made using the set of rules noted above and in accordance with any one of a variety of techniques. For example, the rules, which may be stored in system memory 106 and/or hard drive 112 may include one or more rules covering various scenarios regarding printing. Such rules may address various concerns such as the quantity of the pages to be printed, the desired quality of the print, whether the print is to be black and white or color, the type of media, etc. The rules preferably take into consideration the capabilities of the user's local printer 120 as well as the capabilities of the various remote printers 128.

The rules applied by the remote print rules code 118 to the characteristics of the user's print job can be provided in any desired manner and, in fact, preferably depend, as explained above, on the characteristics of the local and remote printers. One exemplary embodiment of the print rules is provided in FIG. 6 which shows a plurality of rules 200 and a print job destination 202 associated with each rule. Each rule addresses a particular set of printing conditions. For example, rule 204 is directed to a print job in which the user has specified a plain paper media type, 8½×11 inch paper, black and white print, and a quantity of less than or equal to 100. The associated destination 206 is the local printer. Thus, if a user creates a print job which meets the criteria specified in print rule 204, then the remote print rules code 118 directs the print job to the computer's local printer 120.

Print rules 208, 210 and 212 are directed to different sets of criteria which, if met by a user's print job, would result in the remote print rules code 118 directing the print job to a remote printer as indicated at reference numerals 214, 216, and 218. The remote printers 214-218 may be the same or different.

The print rules can be created so as to favor local printing over remote printing whenever reasonably possible, or vice versa if desired. That is, the print rules may direct a print job to a local printer 120 unless the print job falls within the ambit of a print rule targeting a remote destination. In this regard, the rules 200 may only have remote printer-related rules and, unless a particular print job falls within one of those rules, the job will go to a local printer. The reverse can also be true. That is, the rules 200 may include local printer-related rules and, unless a particular print job falls within one of those rules, the job will go to a remote printer.

As an additional feature, the printer driver 114 may prompt the user for confirmation before sending a print job to a remote printer 128. For example, when application of the print rules results in the determination that the user's print job is best suited for a remote printing, the printer driver may cause a window to pop up on the user's computer screen to inform the user that the print job is going to be submitted to a remote printer. The user could also be prompted to click on a button in the window to confirm the remote printing process before the print job can be sent to the remote printer. This confirmation feature can be disabled by the user if desired so that print jobs directed to remote printers 128 are sent there automatically without first requiring confirmation from the user. Further still, the printer driver 114 may be designed so as not to even provide the ability to receive confirmation from the user.

The following discuss explains one technique for how the print rules can be created. The print rule creation process generally includes two steps. First, characteristics for the local and remote printers are collected. Second, an appropriate set of print rules is created from these characteristics.

Addressing the former step, in general, the local printer 120 will have various performance characteristics such as print speed (i.e., number of pages per minute), print quality, color versus black and white, paper type, paper size, etc. Similarly, each of the remote printers 128 will also have certain characteristics that may the same or different between remote printers and may the same or different from the local printer. For example, some remote printers may permit printing on non-paper media (e.g., mugs, shirts, etc.), while other remote printers may be capable of print speeds far greater than that of most inexpensive printers typical of being used as local printers.

The remote printing facilitator 190 (FIG. 4) can be used to assemble the local and remote printer characteristics. Accordingly, the remote printing facilitator preferably would use some or all of the registration information provided by the remote printers 128 during their registration process (described above). Further, the local printer 120 can be any one of a multitude of printer types and brands in the marketplace. The characteristics (e.g., print speed, quality, color capability, paper size, etc.) of a printer is advertised by the printer manufacturer and thus is well known. In accordance with one embodiment, the remote printing facilitator 190 is provided with a list of commercially available printers (to be used as remote printers 120) and the characteristics of each printer.

Once the remote printing facilitator 190 assembles the data set including the remote printers and their characteristics and the printers that could be used by users as local printers and their characteristics, the remote printing facilitator may download that data set to the computer 102 as printer data set 119 preferably stored on hard drive 112. The printer data set 119 may be downloaded each time the computer 102 initializes, at other predetermined times (e.g., once per day at a particular time), each time a print job is initiated by the user, or at any other desired time.

As noted above, the second step of creating the print rules involves using the data set to generate the rules. In accordance with the preferred embodiment, the local printer 102 generates the rules using data set 119. Code, which may be part of, or separate from, remote print rules code 118, can be used in this regard. This code generates rules, such as those shown in FIG. 6, taking into account the characteristics of the local printer 120 relative to the characteristics of the remote printers 120 which have registered themselves via the remote printing facilitator 190. The computer's operating system is aware of the particular local printer coupled thereto and also is aware of the characteristics of that printer from the printer data set 119 downloaded to it from the remote printing facilitator 190. For example, if the local printer is incapable of color printing, then the computer's code 118 knows that all color print jobs must be directed to a remote printer having color capability. By way of an additional example, if the user creates a print job for 1000 pages and the local printer is only capable of a print speed of five pages per minute, the code 118 may determine remote printing to be best in this case to avoid tying up the local printer for the hours it would take to complete that print job locally. On the other hand, if the particular local printer coupled to computer 102 is capable of high speed printing (e.g., 50 pages per minute), then the code 118 may create the print rules to favor local printing instead for the same 1000 page print job.

The code 118 that creates the print rules may be preset with various criteria it uses to create the rules given the characteristics of the local and remote printers. For example, the code 118 may be preset so that any print job with a quantity greater than 100 times the print rate of the local printer should be directed to a high speed remote printer 128 if one has been registered. If the local print rate is, for example, five pages per minute, then all print jobs with a quantity of over 500 pages should be directed to a remote printer. Alternatively, the code 118 can be configured by a user of computer 102. Thus, in the above example, a user can change the threshold to 50 if desired, so that all print jobs with quantities in excess of 250 pages are directed to a remote printer. Further, once the rules are created by code 118, the user may edit the rules and destination printers as desired.

In addition to printer characteristics, price may also be used as a relevant factor when setting up the print rules. Some or all of the remote printers may charge their customers for the use of their service. The charge may be a price per page, a monthly charge, a per job flat rate charge, or, in general, any type of pricing scheme. Price can be used in connection with the print rules in several ways. For instance, if two or more remote printers 128 have acceptable characteristics for a certain type of print job, the code 118 preferably generates the rules so as to favor the remote printer offering a lower price. Further, the user may specify to the code 118 that the user does not wish to pay more than a certain price per page, per mug, etc. Given the user's upper price limit, the code 118 generates the rules accordingly. This may mean sending some print jobs to the local printer that, without the user's price constraints, would have been better suited for a remote printer.

The printer driver may also be designed so as to permit the user to enter a turn around time limit. Thus, the user can specify whether a “rush” job is required or whether the remote printer can take additional time to turn around the user's print job for a more cost effective job. The user can provide such pricing and lead time constraints via selectable fields added to the user interface, such as the interface of FIG. 5.

When the printer driver 114 and/or code 118 determine that a remote printer 128 is best for fulfilling a particular print job, the print job is sent to that remote printer. The remote printer 128 can be accessed via a location identifier (e.g., IP address, URL) in accordance with well known communication techniques. The location identifier may be provided to the computer's printer driver 114 by the remote printing facilitator 190, which is provided the location identifier by the remote printer itself during the registration process. Alternatively, the computer 102 may send the print job to the remote printing facilitator 190 which then forwards the print job on to the target remote printer. Further still, the computer 102 may request the remote printer's location identifier from the remote printing facilitator 190 and, once it has this information, send the print job to the remote printer.

The computer's printer driver may also have access to the user's name and mailing address and can include this information when submitting the print job to the remote printer. Once the remote printer 128 completes the print job, the printed results, be it in the form of paper, mugs, shirts, etc., can be mailed to the user at the user's address. Alternatively, each user can be registered with each of the remote printers. The user's registration may include name and address and any other desired information. This registration process can be conducted directly between the user and remote printer or the remote printing facilitator 190 can register each new user with the remote printers. Either way, each user can be associated with each remote printer by an account number, or other association mechanism. The computer 102 then may include the account number as part of the print job. With the account, the remote printer 128 can determine to whom and to where to send the printed results.

The print job may be formatted in accordance with any desired standard or customized technique. For example, the document to be printed may be converted to a “PDF” file or other file format, or left in the format of the application that created the document in the first place. The miscellaneous information noted above which may be added to the print job (e.g., user name, address, account information, quantity, paper type, etc.) preferably is bundled in a predetermined manner understood by the remote printers and appended to the document to be printed.

It should be understood that the preferred embodiment of the invention is directed to a print management system that provides a great deal of flexibility in coordinating print jobs between local and remote printers. Because the system works with any combination of local and remote printers, there is not one universally “best” set of print rules. Instead, the preferred set of print rules is highly dependent on the particular local and remote printers accessible by the computer 102. The preferred management system described herein is a tool that can be used in connection with any computer system.

The above discussion is meant to be illustrative of the principles and various embodiments of the present invention. Numerous variations and modifications will become apparent to those skilled in the art once the above disclosure is fully appreciated. Components can be added or removed from the circuits and different circuits altogether that provide the same benefits and functionality can be used. It is intended that the following claims be interpreted to embrace all such variations and modifications.

What is claimed is:

1. A computer system, comprising:
a CPU;
a local printer coupled to said CPU;
a network connection through which said CPU can send print jobs to a remote printer;
a storage device coupled to said CPU; and
a printer driver residing on said storage device and executed by said CPU;
said printer driver capable of permitting a print job to submitted to said local printer or said remote printer.

2. The system of claim 1 wherein said local printer is accessed by said CPU via the Internet.

3. The system of claim 1 further including print rules that are accessed by said CPU and permit the CPU to determine whether a print job should be sent to the remote printer or local printer.

4. The system of claim 3 wherein each of said print rules includes a condition and an associated print destination, the print destination being either a local printer or a remote printer.

5. The system of claim 3 wherein said network connection permits said CPU to send print jobs to one of a plurality of remote printers.

6. The system of claim 5 wherein each of said print rules includes a condition and an associated print destination, the print destination being either a local printer or a remote printer.

7. The system of claim 6 wherein said print rules including a rule associated with each of said plurality of remote printers.

8. The system of claim 1 further including a display device and an input device coupled to said CPU through which a user can select one of a plurality of print media types, and the selection of at least one of said print media types causing the print job to be sent to the remote printer.

9. The system of claim 8 wherein the selection of at least one other of said print media types causes the print job to be sent to the local printer.

10. The system of claim 8 wherein said media types that cause the print job to be sent to the remote printer include a print type selected from the group consisting of coffee cup, cake transfer, and shirt.

11. The system of claim 1 further including a display device and an input device coupled to said CPU through which a user can select a remote printing tab as part of the printer driver, the selection of said remote printing tab causing the print job to be sent to the remote printer.

12. The system of claim 11 wherein the selection of said remote printing tab permits the user to select a print job type from the group consisting of flier, business cards, greeting cards and photographs.

13. The system of claim 11 wherein the selection of said remote printing tab permits the user to select a finishing option selected from the group consisting of spiral binding, and transparent cover.

14. The system of claim 11 wherein the selection of said remote printing tab permits the user to preview the order.

15. A printer driver that integrates local and remote printing and that causes a plurality of actions to occur including:
displaying an interactive user interface on a display device;
receiving input selections from a user; and
sending a print job to a locally-coupled printer if said input selections include a first value; or
sending the print job to a remotely-coupled printer if said input selections include a second value.

16. The printer driver of claim 15 wherein said input selection comprises a media type.

17. The printer driver of claim 16 wherein the first value is a media type selected from the group consisting of plain paper, coated paper, glossy/photo paper, transparency, iron-on transfer, greeting card, and coloreal media.

18. The printer driver of claim 16 wherein the second value is a media type selected from the group consisting of cup and cake transfer.

19. The printer driver of claim 15 wherein said first value is a media type available on said locally-coupled printer.

20. The printer driver of claim 19 wherein said second value is a job type available on a remotely-coupled printer.

21. The printer driver of claim 20 wherein said job type is selected from the group consisting of flier, business cards, greeting cards and photographs.

22. The printer driver of claim 19 wherein said second value is a finishing option.

23. The printer driver of claim 22 wherein said finishing option is selected from the group consisting of spiral binding and transparent cover.

24. The printer driver of claim 19 wherein said second value is a remote printing tab included as part of the printer driver, said remote printing tab including one or more user-selectable options to configure a print job for remote printing.

25. A printer driver that integrates local and remote printing and that causes a plurality of actions to occur including:
displaying an interactive user interface on a display device;
receiving input selections from a user;
generating a print job based on said input selections;
comparing said print job to a set of print rules;
sending a print job to a locally-coupled printer if said print job matches to one of a first plurality of said print rules; or
sending the print job to a remote printer if said print job matches to one of a second plurality of said print rules.

26. The printer driver of claim 25 wherein said remotely-coupled printer is accessible over the Internet.

27. A print management system for a computer that can send print jobs to a locally-coupled printer or a remote printer, comprising:
a printer driver that integrates local and remote printing; and
a set of print rules that determines whether a print job is to be sent to the locally-coupled or remote printer.

28. The print management system of claim 27 wherein said print rules includes at least one rule that specifies that the print job should be sent to the locally coupled printer.

29. The print management system of claim 27 wherein said print rules includes at least one rule that specifies that the print job should be sent to the remote printer.

30. The print management system of claim 27 wherein each of said rules specifies one or more print job characteristics.
